(19) United States
(12) Patent Application Publication
(10) Pub. No.: US 2005/0008775 A1
(43) Pub. Date: Jan. 13, 2005

(54) Method of forming dielectric optical thin film

(75) Inventor: Toshiaki Asakawa, Iwata-gun (JP)

Correspondence Address: OLIFF & BERRIDGE, PLC, P.O. BOX 19928, ALEXANDRIA, VA, 22320, US

(73) Assignee: MINEBEA CO., LTD., Kitasaku-gun (JP)

(21) Appl. No.: 10/865,815

(22) Filed: Jun. 14, 2004

(30) Foreign Application Priority Data
Jul. 7, 2003 (JP) 2003-271351

(51) Int. Cl. B05D 5/06

(52) U.S. Cl. 427/163.1; 427/166

(57) ABSTRACT

A method of forming a dielectric optical thin film composed of a dielectric material deposited on a substrate is disclosed. The method comprises a step of applying assist energy directly onto the substrate in an atmosphere of a mixed gas containing hydrogen gas, thereby ionizing the hydrogen gas into hydrogen ion and getting the hydrogen ion to act on the dielectric material being deposited onto the substrate. The action of the hydrogen ion inhibits the crystals of the dielectric material from growing, whereby the dielectric optical thin film is amorphously structured, which reduces scattering in the thin film resulting in increased transmittance. The dielectric material is preferably metal oxide, and the mixed gas contains oxygen gas as well as hydrogen gas, where the hydrogen gas accounts for 0.1 to 2.0% of the total amount of the oxygen gas and hydrogen gas.

### BACKGROUND OF THE INVENTION

1. Field of the Invention

The present invention relates to a method for forming a dielectric optical thin film which has a high refractive index and also a high transmittance.

2. Description of the Related Art

A dielectric optical thin film is formed such that two or more kinds of dielectric materials having respective different refractive indexes are alternately layered on one another. By selectively combining the kinds of dielectric materials layered, a dielectric optical thin film thus formed can be adapted to exclusively transmit light having a specific wavelength while reflecting lights having other wavelengths. Because of the adaptability described above, the dielectric optical thin film can be used as various lenses such as spectacles lenses, or as dichroic mirrors, also as heat reflection coatings provided at windowpanes.

A dielectric optical thin film which uses metal oxide as a dielectric material is formed such that a dielectric material is evaporated at a vacuum process, and evaporated particles produced thereby are deposited onto a substrate in an atmosphere containing oxygen gas. In the method described above, the substrate is heated, and also assist energy is applied by various means for the purpose of facilitating oxidization, stabilizing the structure of a thin-film, and increasing the filling density of a thin film.

One of well-know methods for forming a dielectric optical thin film is performed such that ion beams are irradiated onto a surface of a substrate while a dielectric material is being deposited onto the substrate in a vacuum atmosphere, and the thin film thus formed is annealed in the atmosphere (refer to, for example, Japanese Patent Application Laid-Open No. H11-115711). In this method, ion beams of argon and oxygen produced at ion source are irradiated onto the substrate thereby applying assist energy while a thin film is formed on the substrate. Then, the filling density of the dielectric optical thin film is increased due to the energy of the ion, which contributes to reducing void portions present in the resulting thin film. Moreover, by annealing the thin film in the atmosphere, moisture absorbed in the void portions can be desorbed, whereby the crystallinity of the dielectric optical thin film is enhanced.

Another well-known method for forming a dielectric optical thin film is performed such that oxygen plasma produced by high-frequency discharge passes through an orifice provided at a dielectric plate and having a diameter of 0.3 mm or smaller, and thereby turns into plasma flow dominant to oxygen radicals, and particles evaporated by electron beams from a dielectric material are made to pass through the plasma flow so as to be mixed therewith thereby forming a film (refer to, for example, Japanese Patent Application Laid-Open No. 2000-239830). When oxygen radicals, which are contained in oxygen plasma produced by high-frequency discharge, and which are used as oxidation reaction active species for forming an oxide dielectric thin film, are irradiated onto a substrate as they are, undesired active species such as ions, ultraviolet rays are also irradiated onto the substrate. But in the method, the orifice with a diameter not exceeding 0.3 mm allows only oxygen radicals in oxygen plasma to be selectively irradiated onto the substrate.

Still another well-known method for forming a dielectric optical thin film is performed such that high-frequency power is applied directly onto a substrate to thereby form a dielectric optical thin film with a high filling density in a reduced period of time (refer to, for example, Japanese Patent Application Laid-Open No. 2001-73136). If high-frequency power is applied directly onto a substrate, ions can be accelerated by using negative automatic bias resulting from difference in mobility between electrons and ions in glow discharge, and the accelerated ions are made to impinge on a thin film thereby increasing the filling density of the thin film.

A functional transmitting optical thin film achieves a desired optical characteristic in such a manner that two or more kinds of dielectric thin films having respective refractive indexes different from one another are stacked into a plurality of layers. Larger difference in refractive index from one another is preferred, and a high transmittance is required. It is known that the transmittance of a thin film is deteriorated by three major factors: (1) absorption by a constituent material of a thin film, (2)scattering due to unevenness of a surface of a thin film, and (3) scattering due to a crystalline structure in a thin film.

The deterioration due to the factor (3) can be alleviated by preventing the growth of crystals in a thin film so as to maintain an amorphous structure therein. A dielectric optical thin film can be amorphously structured by lowering a temperature of a substrate, or by decreasing an application amount of assist energy when a film is formed. This, however, decreases the filling density of a thin film, therefore lowering the refractive index of a thin film, and also degrading environmental reliability.

### SUMMARY OF THE INVENTION

The present invention has been made in light of the above problems, and it is an object of the present invention to provide a method for forming a dielectric optical thin film which is free from decreased filling density that is responsible for decrease in refractive index and also for degradation in environmental reliability, and which at the same time is amorphously structured so as to achieve a high transmittance.

The present inventor et al. have been devoted to studying the aforementioned problems, and found out that when a dielectric optical thin film is formed in an atmosphere containing hydrogen gas, the hydrogen gas is ionized by means of assist energy applied, and that if hydrogen ion thus produced acts on a dielectric material being deposited on a substrate so as to form a thin film, crystals of the dielectric material are inhibited from growing whereby the dielectric optical thin film thus formed can be amorphously structured. It has been consequently verified that scattering in the thin film is reduced thereby achieving a high transmittance, and that the filling density of the thin film is sufficiently high thus keeping off decrease in refractive index and degradation in environmental reliability, and the present invention has been completed based on the verification.

In order to achieve the object, according to one aspect of the present invention, there is provide a method for forming a dielectric optical thin film which is composed of a dielectric material deposited on a substrate. The method comprises a step of applying assist energy directly onto the substrate in an atmosphere of a mixed gas containing hydrogen gas, thereby ionizing the hydrogen gas into hydrogen ion and getting the hydrogen ion to act on the dielectric material being deposited onto the substrate.

In the one aspect of the present invention, the hydrogen ion may act on the dielectric material thereby inhibiting growth of crystals in the dielectric material.

In the one aspect of the present invention, the dielectric material may be metal oxide.

In the one aspect of the present invention, the mixed gas may contain oxygen gas as well as hydrogen gas such that the hydrogen gas accounts for 0.1% to 2.0% of the total amount of the oxygen gas and the hydrogen gas.

In the one aspect of the present invention, a thin film may be formed by a vacuum evaporation method.

Since the hydrogen ion acts on the dielectric material which is being deposited on the substrate for a thin film formation, the crystals of the dielectric material are inhibited from growing, whereby the dielectric optical thin film formed has an amorphous structure. Thus, scattering of light in the thin film is reduced thereby achieving a high transmittance. Also, its filling density is sufficiently high thereby achieving satisfactory refractive index and environmental reliability. Consequently, the dielectric optical thin film formed by the method according to the present invention achieves both a high refractive index and a high transmittance, and therefore can be preferably employed for various applications.

### BRIEF DESCRIPTION OF THE DRAWINGS

FIG. 1 is a graph showing absorptance and refractive index of dielectric optical thin films of Inventive Samples and Comparative Samples;

FIG. 2A is an X-ray diffraction diagram on a dielectric optical thin film of an Inventive Sample; and

FIG. 2B is an X-ray diffraction diagram on a dielectric optical thin film of a Comparative Sample.

### DETAILED DESCRIPTION OF THE PREFERRED EMBODIMENTS

The present invention will hereinafter be described. In a method according to the present invention, a dielectric optical thin film is formed in a mixed gas atmosphere containing hydrogen gas, and the hydrogen gas is ionized by applying assist energy directly onto a substrate on which a thin film of a dielectric material is formed. A usual method of forming a dielectric optical thin film in a vacuum process generally comprises: a process (a) where a dielectric material is evaporated to turn into evaporated particles; a process (b) where the evaporated particles move in an atmosphere toward a substrate; and a process (c) where the evaporated particles are deposited onto the substrate thus forming a thin film. In the method according to the present invention, hydrogen ion is adapted to act on the dielectric material at the aforementioned process (c) of the usual method. In order to enable hydrogen ion to act on a dielectric material, assist energy must be applied directly onto the substrate. Assist energy can be applied directly onto the substrate, for example, by irradiating ion beams directly onto the substrate, or applying high-frequency power directly onto the substrate.

If hydrogen ion acts on the dielectric material at the process (c) of the usual method, the crystals of the dielectric material are inhibited from growing. This is attributed to the fact that the dielectric material is inhibited from forming orderly deposition on the substrate if hydrogen ion acts on the dielectric material already deposited on the substrate, or acts on the evaporated particles of the dielectric material in the process of being deposited onto the substrate. Through such an action by hydrogen ion, a thin film of a dielectric material is amorphously formed. Consequently, scattering in the thin film is reduced, and therefore a dielectric optical thin film formed in accordance with the method according to the present invention has a high transmittance.

On the other hand, a high transmittance cannot be achieved on a dielectric optical thin film that is formed by the conventional method, in which evaporated particles of a dielectric material are deposited onto a substrate after passing through a plasma zone containing hydrogen gas. This is because hydrogen ion contained in the plasma zone acts on evaporated particles of a dielectric material while the particles are moving through the plasma zone toward the substrate, which is ineffective in inhibiting the evaporated particles from getting deposited orderly onto the substrate thus allowing crystals of the dielectric material to grow, and accordingly the dielectric optical thin film is formed with a non-amorphous structure.

While any kind dielectric material can be used for a dielectric optical thin film in the method according to the present invention, metal oxide is preferred, such as TiO₂, SiO₂, Nb₂O₅, Ta₂O₅, ZrO₂, HfO₂, Al₂O₃, andOn₂O₃, and a material containing at least one of these metals oxide can be also used. These metals oxide are known as dielectric materials having a high refractive index, and a dielectric optical thin film adapted to transmit only a light beam having a specific wavelength can be formed by appropriately selecting and combining various metals oxide.

In the method of the present invention, a dielectric optical thin film is formed in a mixed gas atmosphere containing hydrogen gas. Since hydrogen gas, when added in an amount within an appropriate range, does not have a significant effect on the filling density of a thin film, the refractive index and environmental reliability of the dielectric optical thin film formed by the method remain favorable. A mixed gas atmosphere contains oxygen gas and a small amount of hydrogen gas is desirable, and the amount of hydrogen gas is preferably set at 0.1 to 2.0% of the aggregate amount of oxygen gas and hydrogen gas. A dielectric optical thin film formed in an atmosphere containing hydrogen gas in the amount described above achieves a high refractive index and at the same time a high transmittance. With hydrogen gas in an amount smaller than 0.1%, the growth of crystals of a dielectric material is not sufficiently inhibited resulting in failing to form a thin film having a high transmittance, while with hydrogen gas in an amount exceeding 2.0%, the filling density of a thin film is lowered resulting in decrease in refractive index and degradation in environmental reliability. The mixed gas may contain inert gases (for example, argon, and krypton) in addition to oxygen gas and hydrogen gas.

The method according to the present invention is characterized by that a dielectric optical thin film is formed in a mixed gas atmosphere containing hydrogen gas. In the method of the present invention, conventionally known methods to use a vacuum process for forming a dielectric optical thin film may be employed. Specifically, a thin film may be formed by an evaporation method, a sputtering method, a chemical vapor deposition (CVD) method, or the like, and most preferably by a vacuum evaporation method which has advantageous features that an equipment required can be comparatively simplified, and also that a principle of forming a thin film is simple.

A dielectric optical thin film formed by the method according to the present invention has a combination of a high refractive index and a high transmittance, and therefore can be favorably used for applications to take apart only a light beam having a specific wavelength. The applications include an anti-reflection film on a camera or glasses, a band-pass filter for optical communications, a laser filter, a dichoric filter for a liquid crystal projector, a cold mirror, and the like.

### EXAMPLES

The present invention will be described with reference to following examples but is not limited thereto.

Thin films of TiO₂, which is a dielectric material having a high refractive index, were formed on respective glass substrates by a vacuum evaporation method such that high-frequency power of 1500W was applied directly onto a substrate heated up to 200 degrees C. in a mixed gas atmosphere which contained oxygen gas and hydrogen gas, and which had its pressure set at 2×10⁻² Pa. When forming the thin films, hydrogen gas in the mixed gas atmosphere had its amounts set at 0.1, 0.5, 1.0, and 2.0% of the total amount of oxygen gas and hydrogen gas, thus producing Inventive Samples 1, 2, 3 and 4, respectively. And, Comparative Samples 1, 2 and 3 were produced by setting the amounts of hydrogen gas respectively at 0.0%, 3.0%, and 4.0% of the total amount of oxygen gas and hydrogen gas.

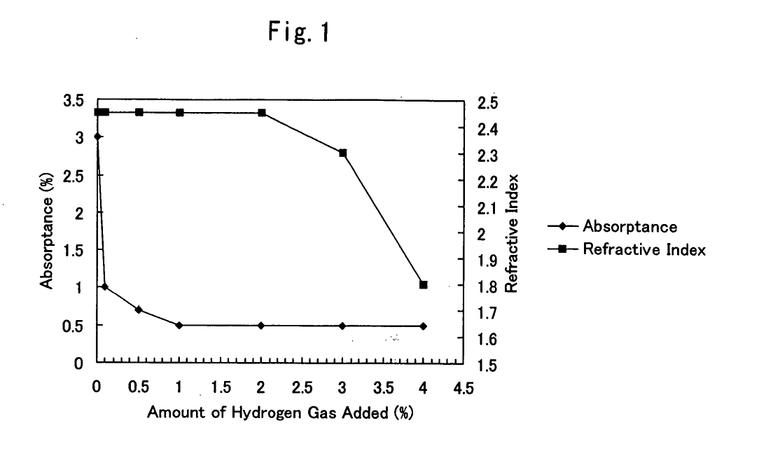

Refractive index and transmission were measured and evaluated on the Inventive and Comparative Samples as follows. Refractive index was measured on light having a wavelength of 550 nm, and transmittance was evaluated on light having a wavelength of 400 nm such that the amount of light absorbed in a glass substrate while passing therethrough was measured and indicated as absorptance in percentage wherein a lower absorptance means a higher transmittance. The measurement results are shown in FIG. 1, where the horizontal axis represents an amount of hydrogen gas added, and the vertical axis represents an absorptance (left side) and a refractive index (right side).

Inventive Sample 1 (hydrogen gas: 0.1%) has a refractive index of about 2.45, and an absorptance of about 1.0% meaning a high transmittance, and shows a favorable characteristic.

Inventive Sample 2 (hydrogen gas: 0.5%) has a refractive index of about 2.45, and an absorptance of about 0.7% which is lower than the absorptance of Inventive Sample 1 meaning a higher transmittance, and shows a more favorable characteristic.

Invention Example 3 (hydrogen gas: 1.0%) has a refractive index of about 2.45, and an absorptance of about 0.5% which is still lower than the absorptance of Inventive Sample 2 meaning a still higher transmittance, and shows an excellent characteristic.

Inventive Sample 4 (hydrogen gas: 2.0%) has a refractive index and an absorptance both almost identical with the refractive index and absorptance of Inventive Sample 3, and shows also an excellent characteristic.

Comparative Sample 1 (hydrogen gas: 0.0%) has a refractive index of about 2.45, but an absorptance of as large as 3.0% meaning a lowered transmittance.

Comparative Sample 2 (hydrogen gas: 3.0%) has its refractive index lowered to 2.3 while keeping its transmittance as high as Invention Examples 3 and 4.

Comparative Sample 3 (hydrogen gas: 4.0%) has its refractive index significantly lowered to 1.8 due to decrease in the filling density of the thin film while keeping its transmittance as high as Inventive Samples 3 and 4, and Comparative Sample 2.

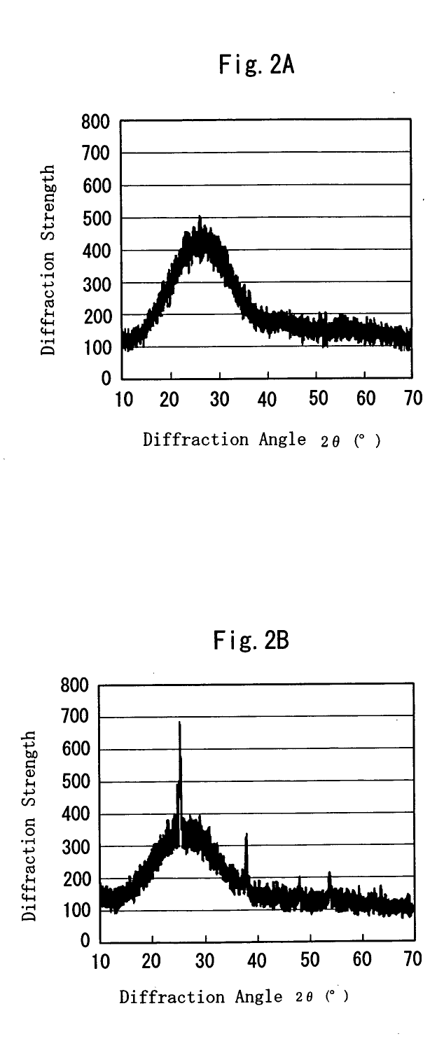

X-ray diffraction measurement was performed on Inventive Sample 2 and Comparative Sample 1, and respective measurement results are shown in FIGS. 2A and 2B, where the horizontal axis represents a diffraction angle 2θ (degrees), and the vertical axis represents a diffraction strength.

In FIG. 2A, no significant diffraction peak is found, which suggests that virtually no crystalline structure is present in the dielectric optical thin film of Inventive Sample 2, indicating that the thin film is amorphously structured. In FIG. 2B, there are several apparent diffraction peaks at diffraction angles 2θ of about 26, 39, 48 and 54 degrees, which indicates that the dielectric optical thin film of Comparative Sample 1 is of a crystalline structure.

Thus, it is known from FIGS. 2A and 2B that in the dielectric optical thin film formed by the method according to the present invention, the growth of crystals is disturbed by action of hydrogen ion produced from hydrogen gas contained in a mixed gas atmosphere in which the thin film is formed, whereby the thin film is provided with an amorphous structure.

While the present invention has been illustrated and explained with respect to specific embodiments or examples thereof, it is to be understood that the present invention is by no means limited thereto but encompasses all changes and modifications that will become possible within the scope of the appended claims.

1. A method of forming a dielectric optical thin film which is composed of a dielectric material deposited on a substrate, the method comprising a step of applying assist energy directly onto the substrate in an atmosphere of a mixed gas containing hydrogen gas, thereby ionizing the hydrogen gas into hydrogen ion and getting the hydrogen ion to act on the dielectric material being deposited onto the substrate.

2. A method of forming a dielectric optical thin film according to claim 1, wherein the hydrogen ion acts on the dielectric material thereby inhibiting growth of crystals in the dielectric material.

3. A method of forming a dielectric optical thin film according to claim 1, wherein the dielectric material is metal oxide.

4. A method of forming a dielectric optical thin film according to claim 1, wherein the mixed gas contains oxygen gas as well as hydrogen gas such that the hydrogen gas accounts for 0.1% to 2.0% of a total amount of the oxygen gas and the hydrogen gas.

5. A method of forming a dielectric optical thin film according to claim 1, wherein a thin film is formed by a vacuum evaporation method.

6. A method of forming a dielectric optical thin film according to claim 2, wherein the dielectric material is metal oxide.

7. A method of forming a dielectric optical thin film according to claim 2, wherein the mixed gas contains oxygen gas as well as hydrogen gas such that the hydrogen gas accounts for 0.1% to 2.0% of a total amount of the oxygen gas and the hydrogen gas.

8. A method of forming a dielectric optical thin film according to claim 3, wherein the mixed gas contains oxygen gas as well as hydrogen gas such that the hydrogen gas accounts for 0.1% to 2.0% of a total amount of the oxygen gas and the hydrogen gas.

9. A method of forming a dielectric optical thin film according to claim 2, wherein a thin film is formed by a vacuum evaporation method.

10. A method of forming a dielectric optical thin film according to claim 3, wherein a thin film is formed by a vacuum evaporation method.

11. A method of forming a dielectric optical thin film according to claim 4, wherein a thin film is formed by a vacuum evaporation method.
